(19) United States
(12) Patent Application Publication
(10) Pub. No.: US 2016/0203026 A1
(43) Pub. Date: Jul. 14, 2016

(54) PROCESSING A HYBRID FLOW ASSOCIATED WITH A SERVICE CLASS

(71) Applicant: HEWLETT PACKARD ENTERPRISE DEVELOPMENT LP, Houston, TX (US)

(72) Inventors: Alkiviadis SIMITSIS, Santa Clara, CA (US); William K. WILKINSON, San Mateo, CA (US); Matteo LISSANDRINI, San Mateo, CA (US)

(21) Appl. No.: 14/917,059

(22) PCT Filed: Sep. 27, 2013
(86) PCT No.: PCT/US2013/062201

§ 371 Date: Mar. 7, 2016

(51) Int. Cl. G06F 9/50

(52) U.S. Cl. CPC G06F 9/5027

(57) ABSTRACT

Described herein are techniques for processing hybrid flows. A hybrid flow may be associated with one of a plurality of service classes and may include sub-flows directed to multiple execution environments. An execution schedule may be generated based on an objective associated with the service class and resource allocation or availability. An action may be taken according to a policy associated with the service class if execution of the hybrid flow fails to meet the objective.

### REFERENCE TO RELATED APPLICATIONS

This application is related to International Patent Application No. PCT/US2013/035080, filed on Apr. 3, 2013 and entitled “Modifying a Flow of Operations to be Executed in a Plurality of Execution Environments”, which is hereby incorporated by reference.

### BACKGROUND

Operations on data can be performed by different types of execution environments. For example, one execution environment can be a database management system (DBMS) environment, in which data is stored in relational tables and subject to database-based operations. As another example, an execution environment can include a MapReduce environment, which performs operations using map tasks and reduce tasks. There can also be other types of execution environments.

### BRIEF DESCRIPTION OF DRAWINGS

The following detailed description refers to the drawings, wherein:

FIG. 1 illustrates a method of processing a hybrid flow associated with a service class, according to an example.

FIG. 2 illustrates a method of managing resources of a plurality of execution environments, according to an example.

FIG. 3 illustrates a method of validating a sub-flow, according to an example.

FIG. 4 illustrates a hybrid flow management system that supports management of hybrid flows associated with multiple service classes, according to an example.

FIG. 5 illustrates a computer-readable medium for processing a hybrid flow associated with a service class, according to an example.

### DETAILED DESCRIPTION

Enterprises (e.g. business concerns, educational organizations, government agencies, etc.) can depend on reports and analyses (generally referred to as “computations”) that integrate data from a diverse collection of data repositories and that operate on the data using a variety of execution environments. In some examples, a single analytic computation can be modeled as a directed graph in which starting nodes are data sources, ending nodes are data targets, intermediate nodes are data operations, and arcs represent data flow. Such a computation can be referred to as an analytic data flow (or simply a “flow”). In other examples, a flow can have a different representation (other than a directed graph). An analytic data flow that utilizes more than one data repository or execution environment is referred to as a hybrid analytic data flow (or simply a “hybrid flow”). A collection of analytic data flows that is managed as a unit for some objective (e.g., the flows should complete before a deadline, or an average response time of individual flows should not exceed a threshold, etc.) is referred to as a workload. A service class workload manager may be used to manage a collection of flows associated with a respective service class.

A hybrid flow can include collections of operations that are performed in different execution environments. A collection of operations of the hybrid flow that is performed in a respective execution environment can be referred to as a sub-flow. There may be multiple sub-flows directed to a single execution environment in a hybrid flow. For example, a single hybrid flow may include three sub-flows directed to a first execution environment and two sub-flows directed to a second execution environment.

Examples of different types of execution environments include at least some of the following: database management system (DBMS) environment, MapReduce environment, an extract, transform, and load (ETL) environment, a mathematical and statistical analysis environment, an event stream processing environment or other execution environments. Each execution environment can include an execution engine and a respective storage repository of data. An execution engine can include one or multiple execution stages for applying respective operators on data, where the operators can transform or perform some other action with respect to data. A storage repository refers to one or multiple collections of data. An execution environment can be available in a public cloud or public network, in which case the execution environment can be referred to as a public cloud execution environment. Alternatively, an execution environment that is available in a private network can be referred to as a private execution environment.

A DBMS environment stores data in relational tables and applies database operators (e.g. join operators, update operators, merge operators, and so forth) on data in the relational tables. A MapReduce environment includes map tasks and reduce tasks that can apply a map function and a reduce function, respectively. A map task processes input data to produce intermediate results, based on the respective map function that defines the processing to be performed by the map task. A reduce task takes as input partitions of the intermediate results from the map task to produce an output, based on the corresponding reduce function that defines the processing to be performed by the reduce tasks.

Another example execution environment includes an ETL environment, which extracts data from a source (or multiple sources), transforms the data, and loads the transformed data into a destination. A mathematical/statistical analysis environment may perform mathematical computation on arrays or vectors of data. An event stream processing environment may perform computations on event streams such as sensor data.

Although specific types of different execution environments are listed above, it is noted that in other examples, other types of execution environments can be used to perform operations on data.

A service class can be associated with a target performance objective, which identifies one or multiple goals that are to be met by the execution of a workload associated with the service class. A performance objective can also be referred to as a service level objective. An example performance objective relates to an execution time (e.g., a time duration for executing the workload or a target deadline by which the workload is to be completed). Another example performance objective is a resource usage objective, which can specify that usage of resources, such as computing resources, storage resources, or communication resources, should not exceed a target level. In other examples, other performance objectives can be employed.

An execution plan for a hybrid flow specifies where (i.e., target execution environments) the sub-flows of the hybrid flow are to execute, and can specify other details associated with execution of the sub-flows (such as order). A single hybrid flow can have many alternative execution plans due to overlap in functionality among the execution environments, multiple implementation details for operations, objectives for the execution plans (e.g. objectives relating to fault-tolerance, latency, etc.), and so forth. Based on an execution plan for a hybrid flow, a management system can deploy the sub-flows of the hybrid flow in the target execution environments, and can orchestrate the execution of the hybrid flow.

There can be several issues associated with deploying an execution plan in the target execution environments. First, the state of a computing infrastructure of at least one execution environment may have changed between the time the execution plan was produced and the time the execution plan is executed. For example, the execution environment may have become overloaded (such that there is contention for resources) or the computing infrastructure may have experienced a fault. Second, the hybrid flow is associated with a performance objective that has to be met. In some cases, penalties may be specified for not meeting performance objectives. Thus, the management system should ensure that target performance objectives are achieved.

In some examples, a workload manager may exist within an individual execution environment, and this workload manager can adjust a priority of a task, the number of concurrently running tasks, and so forth, to increase the likelihood that a workload within the individual execution environment meets a respective target objective. However, a workload manager within a single execution environment can only make decisions optimal for that environment. Such a workload manager has no knowledge of the state of other execution environments. So, for a workload that has flows to be executed across a number of different types of execution environments, workload management becomes more challenging.

In accordance with some implementations, a hybrid flow management system is provided to apply a policy-based hybrid flow management for hybrid flows in a plurality of service classes. The system may include multiple service class workload managers (e.g., one for each service class) to facilitate management of the hybrid flows according to service class.

In an example method, a hybrid flow associated with one of the plurality of service classes may be received. The hybrid flow may include multiple sub-flows directed to multiple execution environments. A schedule may be generated to run the sub-flows on the multiple execution environments based on criteria. The criteria may include one or more objectives associated with the hybrid flow's service class, allocation of resources of the multiple execution environments to the service class, resource availability, and parameters or constraints associated with the hybrid flow. One or more sub-flows may be dispatched for execution in the execution environments. Execution of the dispatched sub-flows may be monitored to generate statistics. A remedial action may be taken according to a policy associated with the service class if the statistics differ from the objective by a threshold. Accordingly, a hybrid flow associated with a service class may be managed to achieve performance objectives. Furthermore, multiple service classes may be supported, such that a hybrid flow associated with any of the service classes may be appropriately managed to achieve performance objectives associated with the respective service class. Additional examples, advantages, features, modifications and the like are described below with reference to the drawings.

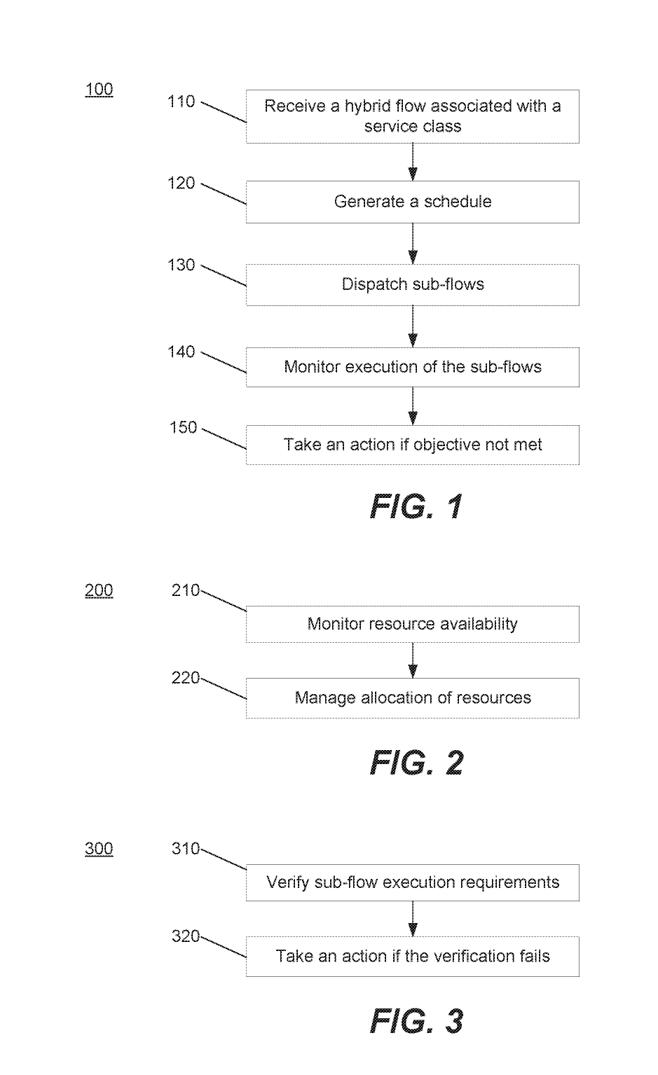

FIG. 1 illustrates a method for processing a hybrid flow associated with a service class, according to an example. Method 100 may be performed by a computing device, system, or computer, such as hybrid flow management system 400 or computing system 500. Computer-readable instructions for implementing method 100 may be stored on a computer readable storage medium. These instructions as stored on the medium are referred to herein as “modules” and may be executed by a computer.

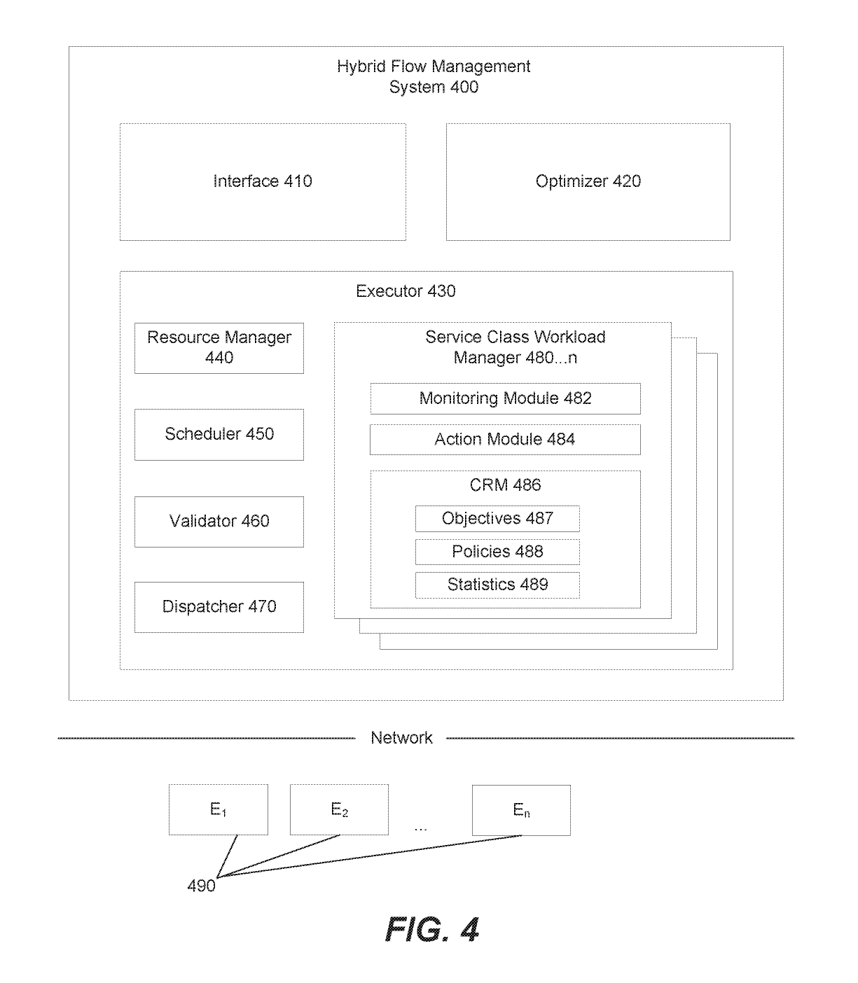

Methods 100-300 will be described here relative to hybrid flow management system 400 of FIG. 4. System 400 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, system 400 may include one or more machine-readable storage media separate from the one or more controllers.

Hybrid flow management system 400 may include a number of components. For example, system 400 may include an interface 410 and optimizer 420. The interface 410 can receive a flow definition for creating or modifying a flow. As an example, the interface 410 can present a graphical user interface (GUI) to allow for users to interactively create or modify a flow. Alternatively, a flow can be written in a declarative language and imported through the interface. The flow that is created or modified using the interface 410 can be a hybrid flow. The optimizer 420 generates multiple candidate execution plans for each flow. The optimizer 420 is able to consider alternative candidate execution plans for a given flow, and can estimate the respective costs of the candidate execution plans. Examples of costs can include processing resource usage cost, storage resource usage cost, communication cost, input/output (I/O) cost, and so forth. An execution plan (which can be an optimal execution plan) from among the candidate execution plans can be selected for execution, where an optimal execution plan can refer to an execution plan that is associated with a lowest cost or that satisfies some other criterion.

System 400 may also include an executor 430 and may be connected to execution environments 490 via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

The optimizer 420 can provide the selected execution plan to the executor 430. The selected execution plan is itself a flow, and is a hybrid flow if it includes sub-flows directed to two or more of execution environments 490. Executor 430 will now be described in more detail with reference to methods 100-300.

Method 100 may begin at 110, where a hybrid flow is received. For example, executor 430 may receive a selected execution plan from the optimizer 420. The hybrid flow may be associated with one of a plurality of service classes supported by the system 400. Service classes are an approach for providing differentiated service for requests.

A service class may be determined and/or assigned to the hybrid flow in various ways. For example, a user may have signed in to interface 410 to create a flow. The user may be associated with a particular service class by user id by virtue of the user's role in the enterprise. For example, if the user id corresponds to a CEO of the enterprise, any generated flow may be assigned to a service class guaranteeing the highest priority (e.g., fastest execution, largest number of allocated resources, eta). In contrast, a user id corresponding to a marketing department or engineering department may be assigned to a service class having a lower priority. The service class may also be dictated by the size of the flow, the type of flow, the number of execution environments required by the flow, etc. A service class may be determined by the geographical location and time of the request origination. Various other methods of determining and/or assigning a service class to a flow may be used.

At 120, a schedule may be generated to run the sub-flows of the hybrid flow on the execution environments. For example, scheduler 450 may be configured to generate the schedule for execution of the sub-flows. Additionally, scheduler 450 may generate a separate schedule for execution of hybrid flows associated with different service classes, such that each service class has its own schedule for execution of flows associated with that service class.

Various scheduling techniques may be used, such as first fit or bin packing. Additionally, the schedule may be generated based on various criteria. For example, the schedule may be generated based on one or more objectives associated with the service class, allocation of resources of the multiple execution environments to the service class, resource availability, and parameters and/or constraints associated with the hybrid flow.

The objectives may be any of various specified service level objectives for the service class (e.g., 90% of flows must complete in fewer than one minute, the entire set of flows must complete by a specified time, etc.). The objectives for a given service class may be stored in computer-readable medium 486 of the corresponding service class workload manager 480 as objectives 487. The scheduler 450 may thus operate under the constraint that the generated schedule meets objectives 487.

The allocation of resources may also be dictated by the service class. For example, each service class may be allocated a set of resources from each execution environment. For instance, a service class may be allocated a number of processing cores, a minimum or maximum amount of memory, a fraction of network bandwidth, etc. Additionally, the allocation of resources may be specific to each execution environment 490. For instance, a service class may be allocated 50% of the processing cores of E₁ but only 25% of the processing cores of E₂.

Resource manager 440 may be used to manage the allocation of resources to the various service classes by assigning particular allocations to the service class workload managers 480. In one example, the allocation of resources among all the service classes should not exceed the total number of resources in the execution environments. In another example, the initial allocation of resources may exceed the total number of resources, but logic in the resource manager 440 may ensure that as the total number in use of any one resource is being approached, the allocated amount of that resource to each service class workload manager 480 is modified so that there isn't resource contention.

Resource manager 440 may perform method 200. At 210, resource manager 440 may monitor resource availability. This may be done by querying the execution environments 490 for their status via an application programming interface. At 220, resource manager 440 may manage the allocation of resources to the service class workload managers 480. As discussed above, the allocation of resources may be dictated by the service classes. For example, each service class may have a set of resource requirements which are communicated to the resource manager 440. As resource availability changes over time (such as due to additional resources being made available in an execution environment, resources failing in an execution environment, etc.), resource manager 440 may modify the resource allocation. Additionally, as discussed later, resource manager 440 may modify the resource allocation in response to requests from the service class workload managers 480. Resource manager 440 may also maintain other parameters and statistics associated with the execution environments, such as a multi-programming level allowed for each environment.

Finally, returning to method 100, the criteria by which the schedule is generated may include parameters and/or constraints associated with the hybrid flow. For example, various sub-flows in the hybrid flow may have dependencies on one another, such that certain sub-flows should be executed concurrently, certain sub-flows should be executed before or after other sub-flows, etc. Also, the hybrid flow may be associated with an arrival time (e.g., the time when the flow first arrived at optimizer 420 or executor 430) and a requested execution time (e.g., a requested time input by a user via interface 410). The parameters may also relate to the number of sub-flows in the hybrid flow, the minimum amount of time needed to fully execute the hybrid flow, the number and type of execution environments needed for execution of the flow, etc. Other parameters and constraints may be considered as well.

Scheduler 450 may take all of these criteria into consideration to generate a schedule for execution of the hybrid flow. Furthermore, the scheduler 450 may generate this schedule for a plurality of hybrid flows associated with the given service class. For example, there may be five independent hybrid flows associated with a given service class that are being managed at the same time by system 400. The scheduler 450 may consider these criteria for all five hybrid flows to generate a schedule for execution of the sub-flows of these five hybrid flows on execution environments 490 such that objectives and constraints associated with the flows are met. Additionally, scheduler 450 may recompute the schedule if a new flow is received, if resources are reallocated, etc.

At 130, one or more of the sub-flows may be dispatched to the execution environments for execution based on the schedule. For example, dispatcher 470 may be configured to dispatch the sub-flows to execution environments 490. However, before dispatching the sub-flows, a validation process may be performed according to method 300 of FIG. 3. Validator 460 may perform method 300. At 310, the execution requirements of a sub-flow to be dispatched may be verified. For example, validator 460 may verify via resource monitor 440 that all resources required for execution of the sub-flow are available and appropriately allocated to the service class. It may also be verified that objectives 487 will be met, that all dependencies have been appropriately satisfied, etc. If the verification succeeds, the sub-flow may be dispatched.

At 320, if the verification fails, an action may be taken. For example, in the event of failure, validator 460 may inform the service class workload manager 480 that the verification failed. Action module 484 of service class workload manager 480 may then take a remedial action(s) in accordance with one or more policies 488. Policies 488 may be specified for each service class to deal with plan invalidation. There may be separate policies for the various circumstances of plan invalidation and the policies may result in different actions being taken.

The following is a non-exhaustive list of remedial actions that may be taken. For example, the service class workload manager 480 may request additional resources from one or more of the execution environments 490. Such a request may entail removing resources allocated to another service class and reallocating those resources to the service class associated with the invalidated sub-flow. The service class workload manager 480 may request instantiation of an additional execution environment. The service class workload manager 480 may request that the given sub-flow be sent to a different execution environment for execution thereon. The service class workload manager 480 may request that the sub-flow be decomposed into smaller fragments. The service class workload manager 480 may request that scheduler 450 generate a new schedule, that optimizer 420 send a new execution plan appropriate to the current state of the computing environments (e.g., from a list of previously generated execution plans), or that optimizer 420 generate a new execution plan altogether.

Returning to method 100, execution of the dispatched sub-flows may be monitored. For example, monitoring module 482of the service class workload manager 480 may monitor execution of the sub-flows associated with the service class. Statistics 489 may be generated based on the monitoring, such as average execution time of the sub-flows, proportion of sub-flows executed, projected total execution time of the hybrid flow, etc. If the statistics differ from one or more objectives 487 by a threshold, action module 484 may take an action according to one or more of policies 488, such as described above.

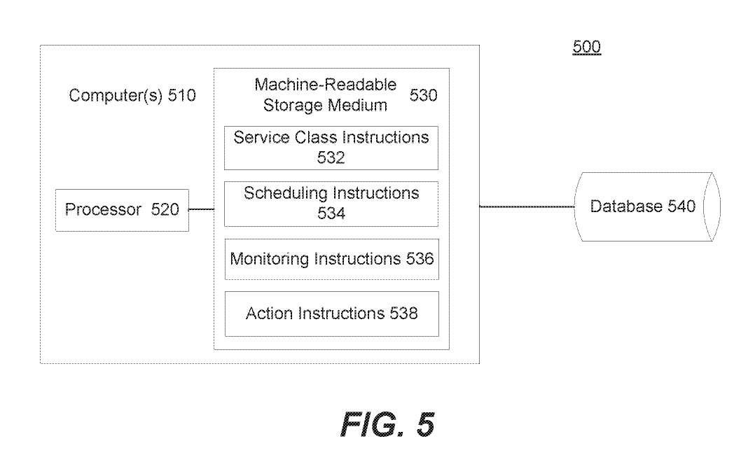

FIG. 5 illustrates a computing system for processing a hybrid flow associated with a service class, according to an example. Computing system 500 may include and/or be implemented by one or more computers. For example, the computers may be server computers, workstation computers, desktop computers, laptops, mobile devices, or the like, and may be part of a distributed system. The computers may include one or more controllers and one or more machine-readable storage media, as described with respect to hybrid flow management system 400, for example.

In addition, users of computing system 500 may interact with computing system 500 through one or more other computers, which may or may not be considered part of computing system 500. As an example, a user may interact with system 500 via a computer application residing on system 500 or on another computer, such as a desktop computer, workstation computer, tablet computer, or the like. The computer application can include a user interface (e.g., touch interface, mouse, keyboard, gesture input device).

Computing system 500 may perform methods 100-300, and variations thereof, and components 510-540 may be configured to perform various portions of methods 100-300, and variations thereof. Additionally, the functionality implemented by components 510-540 may be part of a larger software platform, system, application, or the like. For example, these components may be part of a data analysis system.

Computer(s) 510 may have access to database 540. The database may include one or more computers, and may include one or more controllers and machine-readable storage mediums, as described herein. The computer may be connected to the database via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 520 may be at least one central processing unit (CPU), at least one semiconductor-based microprocessor, other hardware devices or processing elements suitable to retrieve and execute instructions stored in machine-readable storage medium 530, or combinations thereof. Processor 520 can include single or multiple cores on a chip, multiple cores across multiple chips, multiple cores across multiple devices, or combinations thereof. Processor 520 may fetch, decode, and execute instructions 532-538 among others, to implement various processing. As an alternative or in addition to retrieving and executing instructions, processor 520 may include at least one integrated circuit (IC), other control logic, other electronic circuits, or combinations thereof that include a number of electronic components for performing the functionality of instructions 532-538. Accordingly, processor 520 may be implemented across multiple processing units and instructions 532-538 may be implemented by different processing units in different areas of computer 510.

Machine-readable storage medium 530 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 530 can be computer-readable and non-transitory. Machine-readable storage medium 530 may be encoded with a series of executable instructions for managing processing elements.

The instructions 532-538 when executed by processor 520 (e.g., via one processing element or multiple processing elements of the processor) can cause processor 520 to perform processes, for example, methods 100-300, and/or variations and portions thereof.

For example, service class instructions 532 may cause processor 520 to determine a service class associated with each of a plurality of hybrid flows. Scheduling instructions 534 may cause processor 520 to generate a separate execution schedule for the hybrid flows in each service class based on parameters and constraints associated with each hybrid flow, objectives and resource allocation associated with the respective service class, and resource availability. Monitoring instructions 536 may cause processor 510 to monitor the execution of each hybrid flow to generate statistics. Action instructions 538 may cause processor 520 to take a remedial action if the statistics for a given hybrid flow differ from objectives associated with the given hybrid flow's service class by a threshold. The remedial action may be dictated by a policy associated with the given hybrid flow's service class.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method comprising, by a hybrid flow management system:
receiving a hybrid flow comprising multiple sub-flows directed to at least two execution environments, the hybrid flow being associated with a first service class of a plurality of service classes;
generating a schedule to run the hybrid flow's sub-flows on the at least two execution environments based on criteria including an objective associated with the first service class and resource availability of the at least two execution environments;
dispatching a sub-flow of the multiple sub-flows to one of the execution environments for execution based on the schedule;
monitoring the execution of the dispatched sub-flow to generate statistics; and
taking an action according to a policy associated with the first service class if the statistics differ from the objective by a threshold.

2. The method of claim 1, further comprising:
before dispatching the sub-flow to one of the execution environments:
verifying that all resources required for execution of the sub-flow are available; and
taking an action according to a policy associated with the first service class if all resources required for execution of the sub-flow are not available.

3. The method of claim 1, further comprising
monitoring resource availability of the at least two execution environments; and
managing allocation of resources of the at least two execution environments to the plurality of service classes.

4. The method of claim 1, wherein taking an action according to a service policy associated with the first service class comprises requesting additional resources from one or more of the at least two execution environments or requesting an additional execution environment.

5. The method of claim 1, wherein taking an action according to a service policy associated with the first service class comprises decomposing the sub-flow into multiple parts.

6. The method of claim 1, wherein taking an action according to a service policy associated with the first service class comprises selecting a different schedule to run the hybrid flow's sub-flows or generating a different schedule to run the hybrid flow's sub-flows.

7. The method of claim 1, wherein taking an action according to a service policy associated with the first service class comprises sending the sub-flow to a different execution environment for execution.

8. The method of claim 1, comprising:
receiving a second hybrid flow comprising second multiple sub-flows directed to the at least two execution environments, the second hybrid flow being associated with a second service class of the plurality of service classes;
generating a second schedule to run the second hybrid flow's sub-flows on the at least two execution environments based on criteria including a second objective associated with the second service class and resource availability of the at least two execution environments,
wherein the resource availability for the first service class differs from the resource availability for the second service class due to differing allocations of resources of the at least two execution environments to the first and second service classes.

9. A system comprising:
a resource manager to manage allocation of resources of a plurality of execution environments to a plurality of service classes, the plurality of service classes including a first service class;
a scheduler to generate a schedule for execution of a hybrid flow associated with the first service class based on service level objectives associated with the first service class and an allocation of resources to the first service class; and
a service class workload manager associated with the first service class comprising:
a monitoring module to monitor execution of the hybrid flow in the plurality of execution environments; and
an action module to take an action according to a policy associated with the first service class if execution of the hybrid flow fails to meet one or more of the service level objectives associated with the first service class.

10. The system of claim 9, comprising a dispatcher to dispatch sub-flows of the hybrid flow to the plurality of execution environments for execution according to the schedule.

11. The system of claim 10, comprising a validator to validate a sub-flow before dispatch by the dispatcher by verifying that resources required for execution of the sub-flow are available and that the objectives are expected to be met.

12. The system of claim 9, wherein the policy causes the action module to request additional resources from the resource manager.

13. The system of claim 9, wherein the policy causes the action module to request that a sub-flow of the hybrid flow be sent to another execution environment for execution.

14. The system of claim 9, comprising:
a second service class workload manager associated with a second service class of the plurality of service classes, the second service class workload manager comprising:
a second monitoring module to monitor execution of hybrid flows associated with the second service class in the plurality of execution environments; and
a second action module to take an action according to a policy associated with the second service class if execution of one of the hybrid flows associated with the second service class fails to meet one or more service level objectives associated with the second service class.

15. A non-transitory computer-readable storage medium storing instructions for execution by a computer, the instructions when executed causing the computer to:
determine a service class associated with each of a plurality of hybrid flows;
generate a separate execution schedule for the hybrid flows in each service class based on parameters and constraints associated with each hybrid flow, objectives and resource allocation associated with the respective service class, and resource availability;
monitor the execution of each hybrid flow to generate statistics; and
take a remedial action if the statistics for a given hybrid flow differ from objectives associated with the given hybrid flow's service class by a threshold, the remedial action being dictated by a policy associated with the given hybrid flow's service class.
